(19) United States
(12) Patent Application Publication
(10) Pub. No.: US 2012/0154482 A1
(43) Pub. Date: Jun. 21, 2012

(54) Print Head Maintenance Manifold System

(76) Inventors: Casey E. Walker, Boulder, CO (US); Stuart J. Boland, Denver, CO (US)

(21) Appl. No.: 12/973,309

(22) Filed: Dec. 20, 2010

(51) Int. Cl. B41J 2/165

(52) U.S. Cl. 347/22

(57) ABSTRACT

A print head maintenance manifold assembly is disclosed. The maintenance manifold assembly includes a multitude of hoses and a manifold coupled to the hoses via fittings. The manifold includes a first set of fittings and small diameter hoses coupled to print heads at a first section of the manifold and a second set of fittings and hoses coupled to a vacuum source at a second section of the manifold.

### FIELD OF THE INVENTION

This invention relates generally to the field of ink jet printing systems. More particularly, the invention relates to maintaining a print engine within an ink jet printing system.

### BACKGROUND

An ink jet printer is an example of a printing apparatus that ejects droplets of ink onto a recording medium, such as a sheet of paper, for printing an image on the recording medium. The ink jet printer includes a print engine having one or more ink jet print heads provided with an ink cartridge that accommodates the ink. In operation of the print engine, the ink is supplied from the ink cartridge to each ink jet print head having ejection nozzles, so that a printing operation is performed by ejection of the ink droplets from selected ejection nozzles.

However, ink jet printers may suffer from one or more problems leading to nozzle clogging and the inability to fire an ink droplet under normal conditions. A clogged nozzle may not only result in diminished print quality, but may also require the expense of replacing the entire ink jet print head. Thus, ink jet print heads are regularly maintained to ensure usability.

Maintenance of ink jet print heads typically involves a maintenance station that generates a vacuum that is used to pull ink through the print head to the maintenance station. Further, an ambient air system is implemented to relieve the vacuum prior to disengaging the print head from the maintenance station. Maintenance stations often include a manifold assembly of one or more manifolds coupled together via fittings and hoses.

Additionally, numerous hoses are coupled to the manifolds, each with at least one fitting. The manifold hose fittings are potential vacuum leak points that reduce effectiveness of the vacuum at the print head. Having a relatively large number of fittings increases the number of possible vacuum leak points also makes maintenance manifold assemblies, and therefore maintenance stations, more difficult to service and/or replace.

Finally, a maintenance station utilizing relatively large diameter hoses coupled to the print head nozzle plates results in a low velocity flow of ink through the hoses from the print head. The low velocity flow of ink through the maintenance manifold assembly hoses is more likely to allow obstructions to remain inside the hoses, reducing vacuum effectiveness.

Therefore, a maintenance manifold assembly with a reduced number of fittings and smaller diameter hoses that reduces possible vacuum leak points, prevents clogs, lowers response time, and enables more efficient servicing and replacement is desired.

### SUMMARY

In one embodiment, a print head maintenance manifold assembly is disclosed. The maintenance manifold assembly includes a multitude of hoses and a manifold coupled to the hoses. The manifold includes a first set of fittings and smaller diameter hoses coupled to print heads at a first section of the manifold and a second set of fittings and larger hoses coupled to a vacuum source at a second section of the manifold.

In a further embodiment, a manifold includes a first port, a first row of print head fittings coupled to a first end of the first port and a first vacuum fitting coupled to a second end of the first port.

### BRIEF DESCRIPTION OF THE DRAWINGS

A better understanding of the present invention can be obtained from the following detailed description in conjunction with the following drawings, in which:

FIG. 1 illustrates one embodiment of a system;

FIG. 2 illustrates a conventional maintenance manifold assembly; and

FIGS. 3A-3F illustrates various views of an embodiment of a maintenance manifold.

### DETAILED DESCRIPTION

A print head maintenance station is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

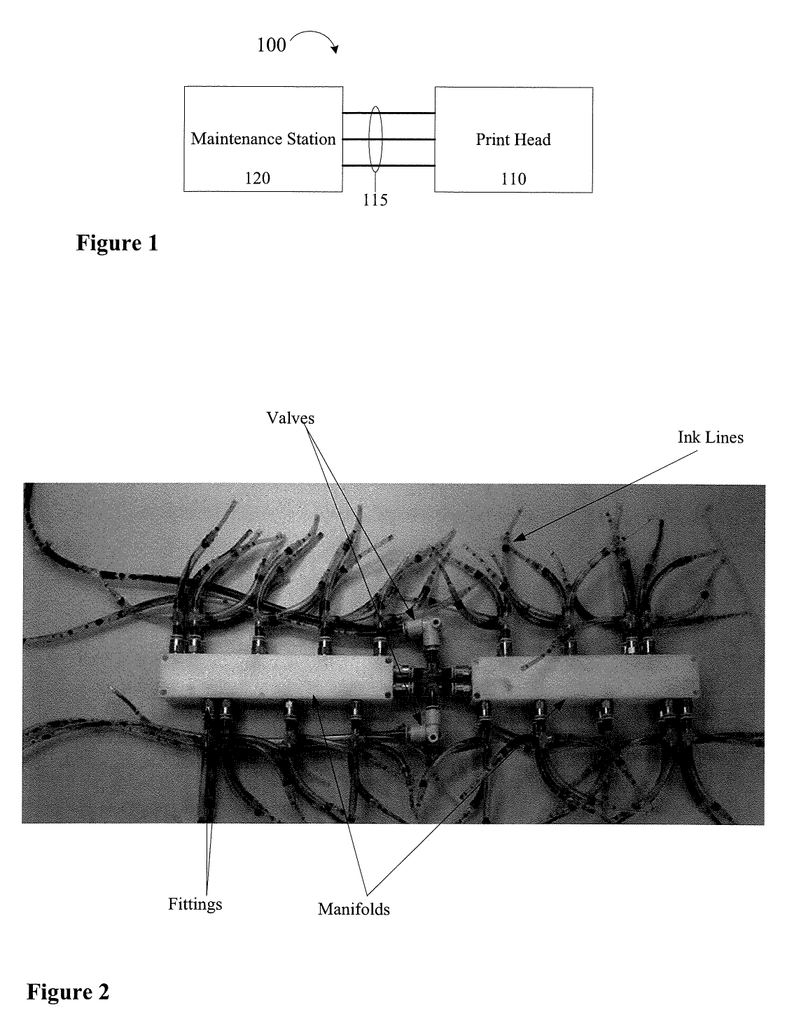

FIG. 1 illustrates one embodiment of a system 100. System 100 includes a print head 110 and a maintenance station 120. In one embodiment, print head 110 is a component of an ink jet print engine that supplies ink from an ink cartridge to a medium via a multitude of nozzles. Maintenance station 120 is used to maintain print head 110 by pulling ink through and from the print head to the maintenance station via a vacuum.

FIG. 2 illustrates a conventional maintenance manifold assembly. The maintenance manifold assembly includes two manifolds coupled together by hoses and fittings. The junction of the two manifolds includes additional fittings, half of which are coupled to a vacuum source and half to ambient air. The manifold assembly is used to provide a vacuum or ambient air to the print head via a plurality of hoses coupled between the manifolds and print head nozzle plate. Additionally, each manifold is coupled to the hoses by fittings.

As shown in FIG. 2, the maintenance manifold assembly is a complex system with numerous fittings. The prevalence of so many fittings provides an increase in risk of vacuum leak if one of the fittings is not properly sealed. Moreover, such complexity of parts in the maintenance station makes it difficult to maintain. Thus, to maintain it is often necessary to replace the entire system of manifolds, hoses and fittings.

Also the maintenance manifold assembly shown in FIG. 2 uses smaller diameter hoses that transition to larger diameter hoses between the print head nozzle plates and the manifolds, which creates lower velocity flow of ink in the larger diameter hoses. The lower velocity ink flow inside the larger diameter hoses facilitates ink clogging inside the hoses, thus requiring additional servicing or replacement of the manifold assembly.

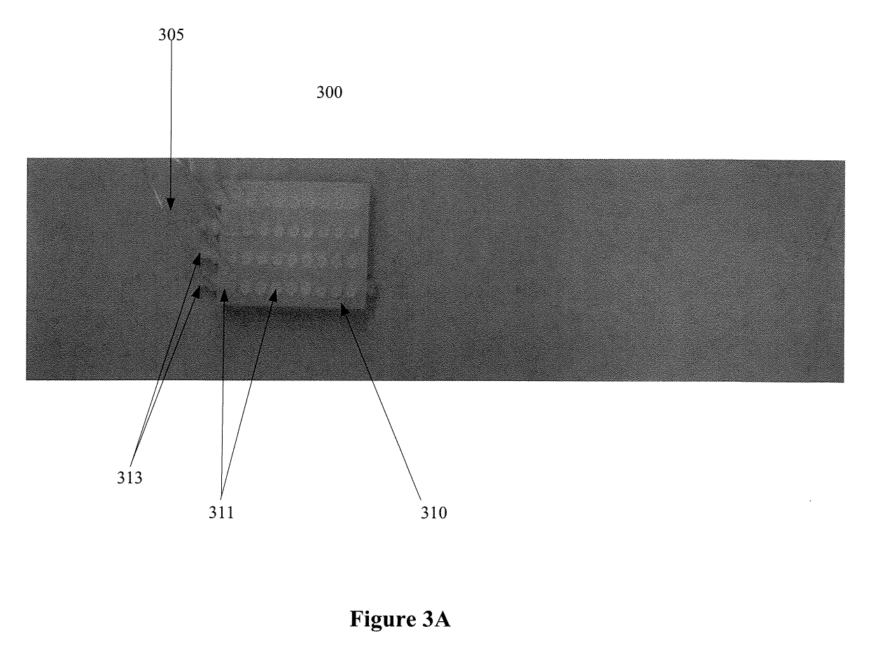

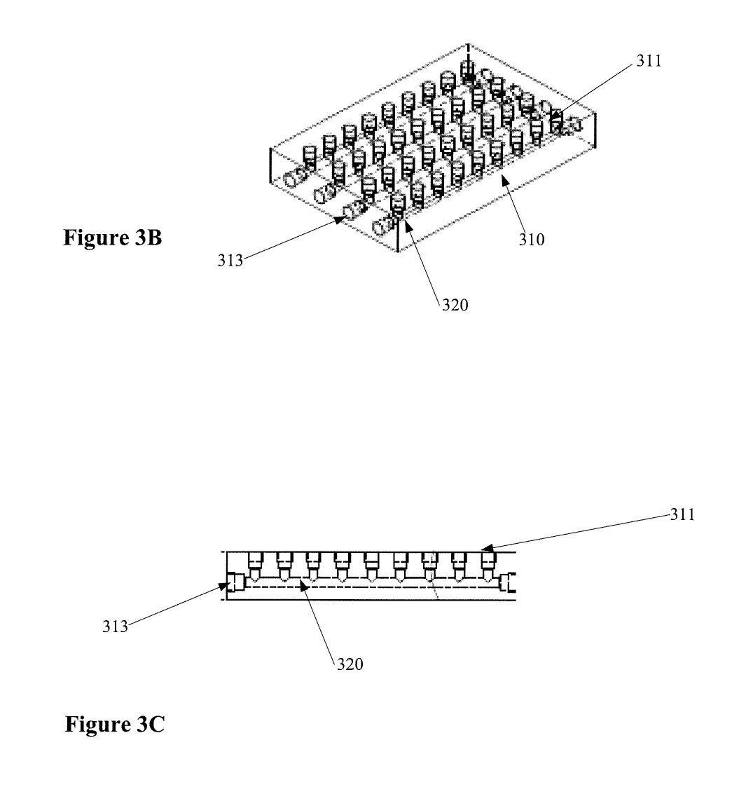

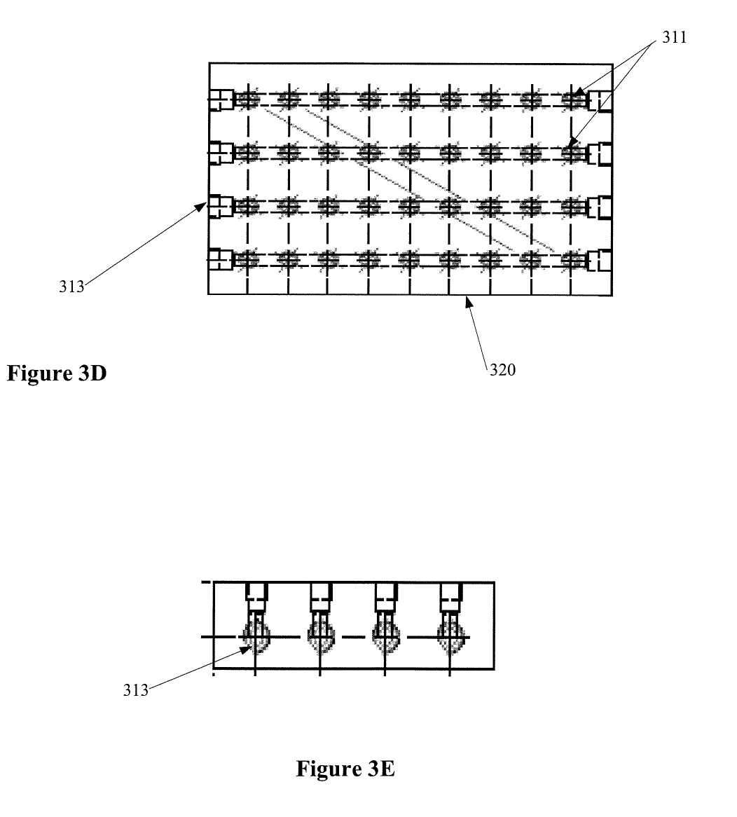

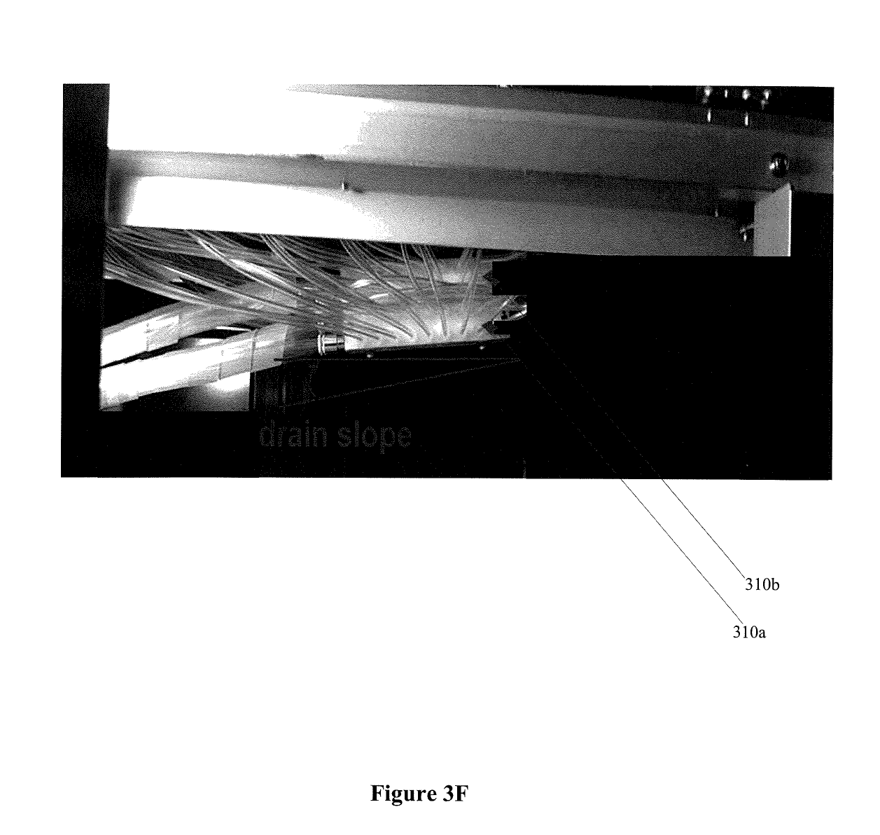

According to one embodiment, a compact maintenance manifold assembly is provided. FIGS. 3A-3D illustrate various views of one embodiment of a maintenance manifold assembly. FIG. 3A illustrates one embodiment of a top view of maintenance manifold assembly 300. Maintenance manifold assembly 300 includes a manifold 310 having fittings 311 for coupling to hoses 305. Hoses 305 are coupled to print head 110 and are implemented to carry ink from print head 110 to manifold 310.

In one embodiment, hoses 305 are small diameter hoses that increase the ink velocity from print head 100 to manifold assembly 300. Increasing ink velocity enhances the ability to remove obstructions thereby prevents clogging. Further, the implementation of smaller diameter hoses reduces a vacuum response time of the system.

With larger hose diameters, a vacuum is generated over a period of time as a result of a vacuum pump capacity and a volume of air that must be removed from the system to generate sufficient vacuum at the print head to facilitate an effective print head cleaning process. Accordingly, the use of small diameter hoses allows air to be removed very rapidly from maintenance manifold assembly 300, resulting in a vacuum impulse. The vacuum impulse increases print head cleaning effectiveness. In other embodiments, the vacuum impulse effect can be created using vacuum chambers or higher capacity vacuum pumps.

Maintenance manifold assembly 300 also includes fittings 313 coupled at an end of manifold 310. FIG. 3B illustrates one embodiment of an isometric view of maintenance station 300 showing a port 320 coupled to each of fittings 313. In one embodiment, each of fittings 313 are coupled to a vacuum source via a hose to provide the vacuum to manifold 310.

Further, it is shown in FIG. 3B that a row of fittings 311 are integrated into each port 320. FIG. 3C is a side view of maintenance manifold assembly 200 showing a more detailed cross-section of a coupling of a port 320 between a fitting 313 and a row of fittings 311. In this embodiment, plugs are installed at the right end of ports 320.

As discussed above, a vacuum is provided at each port 320 via a respective fitting 313. Thus, the vacuum presented at port 320 enables ink to be pulled into manifold 310 from a print head via hoses 305 and fittings 311, and out through fittings 313. In other embodiments, separate ambient air ports may be provided to relieve the vacuum in order to prevent damage to the print head prior to removing a print head from the maintenance station.

FIG. 3D is a top view of maintenance manifold assembly 300 illustrating each row of fittings 311 coupled to port 320. According to one embodiment, each of fittings 311 include a crush seal fitting to create an air tight seal with the manifold. According to one embodiment, the crush seal fitting is created by using a tapered ledge in a drilled hole to create a fitting interference surface.

The fitting interference surface is then used in combination with a threaded fitting to generate a deformation in the fitting, which creates a sealing surface without the use of an o-ring, sealing washer, thread tape or thread sealing tape. Thus, the crush seal fitting configuration employs a threaded fitting that deforms at the sealing surface to create a seal. FIG. 3E is a side view of maintenance station 300 illustrating a similar crush seal configuration for fittings 313.

According to one embodiment, the components of maintenance manifold assembly 300 are composed of polyoxymethylene, polypropylene, and brass. However in other embodiments, other materials are used for one or more of the components of maintenance station 300. FIG. 3F is a side view of maintenance station 300 installed at print head 110. In this embodiment, maintenance station 300 includes vacuum manifold 310a and ambient manifold 310b, where each manifold is coupled to a draining tube. In one embodiment, the manifolds 310 are mounted on a drain slope (or angle) to facilitate fluid drainage and reduce ink build-up and blockages resulting from ink build-up.

The above-described maintenance manifold assembly provides a compact design that replaces complex maintenance manifold assemblies requiring multiple manifolds and hundreds of fittings in order to maintain a set of print heads. Particularly, the present design eliminates in excess of five hundred fittings required in conventional systems. Thus, simple diagnosis of problems at, and less invasive replacement of, a maintenance manifold assembly is achieved.

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A print head maintenance manifold assembly comprising:
a multitude of hoses; and
a manifold coupled to the hoses, including:
a first set of fittings coupled to the hoses at a first section of the manifold; and
a second set of fittings coupled to a vacuum source at a second section of the manifold.

2. The print head maintenance manifold assembly of claim 1 wherein the manifold further comprises a first port coupled between a first row of the first set of fittings and a first of the second set of fittings.

3. The print head maintenance manifold assembly of claim 2 wherein the manifold further comprises a second port coupled between a second row of the first set of fittings and a second of the second set of fittings.

4. The print head maintenance manifold assembly of claim 1 wherein the manifold further comprises a third set of fittings having a first fitting coupled to the first port at an opposite end of the first of the second set of fittings and a second fitting coupled to the second port at an opposite end of the second of the second set of fittings.

5. The print head maintenance manifold assembly of claim 1 wherein the first side of the manifold is the top of the manifold and the second side of the manifold is a side adjacent to the top of the manifold.

6. The print head maintenance manifold assembly of claim 1 wherein the hoses are small diameter hoses that increase flow velocity to the manifold.

7. The print head maintenance manifold assembly of claim 6 wherein the small diameter hoses allow a vacuum impulse.

8. The print head maintenance manifold assembly of claim 1 wherein the manifold is mounted at a slope to facilitate fluid drainage.

9. A manifold comprising:
a first port;
a first row of print head fittings coupled to a first end of the first port; and
a first vacuum fitting coupled to a second end of the first port.

10. The manifold of claim 9 further comprising:
a second port;
a second row of print head fittings coupled to a first end of the second port; and
a second vacuum fitting coupled to a second end of the second port.

11. The manifold of claim 10 wherein the first and second row of print head fittings are coupled to a print head via hoses and the first and second vacuum fittings are coupled a vacuum source via hoses.

12. The manifold of claim 11 wherein the hoses are small diameter hoses that increase flow velocity to the manifold.

13. The manifold of claim 12 wherein the small diameter hoses allow a vacuum impulse.

14. The manifold of claim 9 wherein manifold is mounted at a slope to facilitate fluid drainage.

15. A system comprising:
a print engine including one or more ink jet print heads;
a plurality of small diameter hoses coupled to the one or more print heads; and
a manifold coupled to the hoses, including:
a first set of fittings coupled to the plurality hoses; and
a second set of fittings coupled to a vacuum source.

16. The system of claim 15 wherein the manifold further comprises a first port coupled between a first row of the first set of fittings and a first of the second set of fittings.

17. The system of claim 16 wherein the manifold further comprises a second port coupled between a second row of the first set of fittings and a second of the second set of fittings.

18. The system of claim 15 wherein each of the first and second set of fittings comprise a crush seal fitting to create an air tight seal.

19. The system of claim 18 wherein a crush seal fitting is created by using a tapered ledge in a drilled hole to create a fitting interference surface.

20. The system of claim 19 wherein the fitting interference surface is used in combination with a threaded fitting to generate a deformation in the fitting to create a sealing surface.
